(19) United States
(12) Patent Application Publication
(10) Pub. No.: US 2011/0184104 A1
(43) Pub. Date: Jul. 28, 2011

(54) PROCESS FOR THE PREPARATION OF PHENOLSULFONIC ACID-ALDEHYDE CONDENSATES AND THE USE THEREOF AS DRYING AGENTS

(75) Inventors: Corinna NAUNDORF, Waldbronn (DE); Sebastien Garnier, Berlin (DE); Ulf Dietrich, Calw-Altburg (DE); Michael Kluge, Worms (DE)

(73) Assignee: BASF SE, Ludwigshafen (DE)

(21) Appl. No.: 13/011,367

(22) Filed: Jan. 21, 2011

(30) Foreign Application Priority Data
Jan. 25, 2010 (EP) 10151556.7
Jan. 25, 2010 (JP) 1015156.7

(51) Int. Cl. C08K 5/42; C08F 20/56; C08L 33/26

(52) U.S. Cl. 524/158; 252/182.3; 526/307.2; 524/555

(57) ABSTRACT

The present invention relates to a process for the preparation of phenolsulfonic acid-aldehyde condensates and the use thereof as drying agents, in particular in the spray drying of aqueous polymer dispersions.

The present invention relates to a process for the preparation of phenolsulfonic acid-aldehyde condensates and the use thereof as drying agents, in particular in the spray drying of aqueous polymer dispersions.

The present invention furthermore relates to a process for the preparation of polymer powders redispersible in an aqueous medium and to the redispersible polymer powders and their use.

Aqueous polymer dispersions are widely used, for example as binders, in particular for synthetic resin renders or highly pigmented interior paints, adhesives and coating materials. Frequently, however, it is desired to use not the aqueous polymer dispersion but the polymer in powder form.

In order to obtain the polymer in powder form, the dispersion must be subjected to a drying process, for example spray drying or even freeze drying. In spray drying, the polymer dispersion is sprayed in a warm air stream and dewatered, the drying air and the spray dispersion preferably being fed concurrently through the dryer.

However, the polymer powder obtained has the disadvantage that its redispersibility in an aqueous medium is generally not completely satisfactory because the polymer particle diameter distribution resulting from redispersing is as a rule different from that in the aqueous starting dispersion. The reason for this is that aqueous polymer dispersions, in contrast to polymer solutions, do not form thermodynamically stable systems. Rather, the system attempts to reduce the size of the polymer/dispersing medium interface by combining small primary particles to form larger secondary particles (specks, coagulums). In the state of the disperse distribution in the aqueous medium, this can be prevented by addition of dispersants, such as emulsifiers and protective colloids, even for a relatively long time. During the drying of aqueous polymer dispersions, however, the effect of the dispersants is frequently no longer sufficient and in certain circumstances irreversible secondary particle formation occurs. This means that the secondary particles are preserved during the redispersing and reduce the performance characteristics of the aqueous polymer dispersion obtainable in the redispersing.

In order to prevent or at least to reduce the secondary particle formation during drying, it has long been known to use so-called drying agents. These are often designated as spraying assistants since the spray drying particularly promotes formation of irreversibly agglomerated secondary particles. This effect is all the more pronounced the lower the glass transition temperature (and hence the softening temperature or the minimum film formation temperature) of the polymer particles, particularly when it is below the drying temperature. At the same time, drying agents as a rule reduce the formation of polymer coating remaining adhering to the drier wall and thus increase the powder yield.

The use of drying agents is known from numerous publications. Thus, DE-A-24 45 813 describes a pulverulent polymer which is redispersible in aqueous systems and comprises, as a drying agent, from 1 to 20% by weight of a water-soluble condensate of aromatic hydrocarbons and formaldehyde, which condensate contains sulfo or sulfonate groups. These condensates are in particular phenolsulfonic acid- or naphthalenesulfonic acid-formaldehyde condensates. No information is given about the molecular weight of the condensates used. It is pointed out that the drying of the polymer powders should be carried out at temperatures below the softening temperature.

EP-A-78 449 describes a process for the preparation of blocking-resistant polymer powders redispersible in water by spray drying of aqueous dispersions of polymers having glass transition temperatures below 50° C. The dispersions comprise, as spraying assistants, a water-soluble copolymer of vinylpyrrolidone and vinyl acetate and/or water-soluble alkali metal and/or alkaline earth metal salt of a naphthalenesulfonic acid-formaldehyde condensate. Here too, no information is given about the molecular weight of the naphthalenesulfonic acid-formaldehyde condensates used. What is striking is the comparatively large amount of spraying assistant when the naphthalenesulfonic acid-formaldehyde condensates are used alone (30% by weight in example 4, 50% by weight in example 5, 30% by weight in example 6, based in each case on the polymers). This leads to an adverse effect on the binder properties of the polymer powders, for example the flowability of materials bound therewith is increased to an undesired extent (cf. EP 407 889) or the setting behavior of cementitious materials is retarded.

In a similar manner, EP-A-407 889 describes the use of a water-soluble alkali metal or alkaline earth metal salt of a phenolsulfonic acid-formaldehyde condensate as a spraying assistant for the preparation of polymer powders redispersible in water from aqueous polymer dispersions. Here too, no information is given about the molecular weight of the condensates used. The redispersibility of polymer powders which are obtained with the use of commercially available phenolsulfonic acid-formaldehyde condensates is, however, just as unsatisfactory as the powder yield on drying.

EP-A-914 365 likewise describes the use of a water-soluble alkali metal and/or alkaline earth metal salt of a phenolsulfonic acid-formaldehyde condensate as a spraying assistant of aqueous polymer dispersions. Here, an Mn<1500 is stated as a particularly suitable molecular weight of the condensate. The polymer powders are obtained in good yields with the use of these condensates and have good redispersibility. However, a disadvantage is the color of the polymer powders obtained, which may sometimes be brownish to reddish.

WO 2005/021145 describes a redispersible polymer powder which comprises o-cresolsulfonic acid-formaldehyde condensates. o-Cresolsulfonic acid-formaldehyde condensates have the advantage that better control of molecular weight is possible during their preparation.

WO 2006/034531 discloses a redispersible powder which comprises an o-cresolsulfonic acid-formaldehyde condensate which comprises a certain amount of nitrogen-containing components. An advantage of the nitrogen-containing condensates is the lower level of coloration of the redispersible powders prepared.

It was the object of the present invention to provide drying agents which result in little coloration of the redispersible polymer powder even without additional nitrogen-containing compounds.

Surprisingly, it was found that rapid addition of the aldehyde to the phenolsulfonic acid, the rate of addition being chosen so that the reaction temperature is preferably ≦80° C., particularly preferably ≦70° C., and neutralization of the resulting phenolsulfonic acid condensate not beyond a pH of 8, preferably 7.5, results in substantially less coloration of the polymer powder to be prepared.

The invention therefore relates to a process for the preparation of a phenolsulfonic acid-aldehyde condensate, wherein the rate of addition is chosen so that the reaction temperature is preferably ≦80° C., particularly preferably ≦70° C., and the neutralization of the resulting phenolsulfonic acid condensate does not take place beyond a pH of 8, preferably 7.5.

The phenolsulfonic acid-aldehyde condensate prepared by the process according to the invention results in less coloration in the redispersed powder.

The invention furthermore relates to the use of phenolsulfonic acid-aldehyde condensate as a spraying assistant for drying aqueous polymer dispersions.

If the condensate is used in the form of its salts, as a rule alkali metal or alkaline earth metal or ammonium salts are used, i.e. salts with ammonia or organic amines, such as triethanolamine, diethanolamine or triethylamine. Preferably, the alkaline earth metal salts and in particular the calcium salts are used.

The preparation of the drying agents used according to the invention is effected as a rule by condensation of phenolsulfonic acid with the aldehyde under acidic reaction conditions, in particular in the presence of sulfuric acid. The phenolsulfonic acid can be initially taken or prepared in situ by sulfonation by known methods (cf. J. March, Advanced Organic Chemistry, 3rd ed, John Wiley, New York 1985, page 473 et seq. and literature cited there). Preferably, phenolsulfonic acid is prepared in situ by sulfonation with sulfuric acid, preferably concentrated sulfuric acid. The condensation is effected by reaction of phenolsulfonic acid with aldehyde under acidic reaction conditions, preferably in the presence of sulfuric acid, in particular in concentrated sulfuric acid. If the phenolsulfonic acid is prepared in situ, the condensation is initiated by addition of aldehyde to the reaction mixture. The molar aldehyde:phenolsulfonic acid ratio is in the range from 1:1 to 1:2, preferably in the range from 1:1.3 to 1:1.7. Preferably, the aldehyde is added as an aqueous solution.

The term aldehyde according to the invention is understood as meaning formaldehyde, acetaldehyde, glyoxal, glutaraldehyde or mixtures thereof, preferably formaldehyde.

The addition is effected as rapidly as possible, the rate of addition being chosen so that the reaction temperature is ≦80° C., preferably ≦70° C.

The present invention also relates to a process for the preparation of a polymer powder by drying an aqueous polymer dispersion, at least one phenolsulfonic acid-aldehyde condensate of the type described above or a salt thereof being used as the drying agent. Condensates are used as a salt in the case of polymer dispersions which have been rendered alkaline and in acid form in the case of polymers which have been rendered acidic.

The amount of drying agents which is used is preferably from 1 to 30% by weight, based on the weight of the polymer of the dispersion, preferably from 3 to 15% by weight and particularly preferably from 5 to 12% by weight.

The compounds according to the invention are particularly advantageous for drying polymer dispersions in which the polymer has a glass transition temperature (DSC, midpoint temperature, ASTM D 3418-82) ≦65° C., preferably ≦50° C., particularly preferably ≦25° C. and very particularly preferably ≦0° C. In general, the glass transition temperature of the polymers is ≧−60° C., preferably ≧−40° C. and in particular ≧−20° C.

According to Fox (cf. Ullmanns Enzyklopädie der technischen Chemie, 4^{th} edition, volume 19, Weinheim (1980), pages 17, 18), the glass transition temperature TG can be estimated. For the glass transition temperature of weakly crosslinked or uncrosslinked copolymers with high molar masses, the following is true to a good approximation:

$$\frac{1}{Tg} = \frac{{X}^{1}}{{Tg}^{1}} + \frac{{X}^{2}}{{Tg}^{2}} + … \frac{{X}^{n}}{{Tg}^{n}}$$

in which X¹, X², . . . , Xⁿ are the mass fractions 1, 2, . . . , n and T_{g}¹, T_{g}², T_{g}ⁿ are the glass transition temperatures of the polymers composed in each case of one the monomers 1, 2, . . . , n, in degrees Kelvin. The latter are known, for example, from Ullmann's Encyclopedia of Industrial Chemistry, VCH, 5.ed. Weinheim, Vol. A 21 (1992) page 169, or from J. Brandrup, E. H. Immergut, Polymer Handbook 3^{rd} ed, J. Wiley, New York 1989.

They are preferably polymers which are composed of

(a) from 80 to 100% by weight of at least one monomer which is selected from vinylaromatic compounds, esters of α,β-monoethylenically unsaturated C₃-C₆-carboxylic acids or C₄-C₈-carboxylic acids with C₁-C₁₂-alkanols, preferably C₁-C₈-alkanols, vinyl and allyl esters of C₁-C₁₂-carboxylic acids, vinyl chloride, vinylidene chloride and butadiene, and
(b) from 0 to 20% by weight of at least one further monomer which has at least one ethylenically unsaturated bond.

Here, the expressions Cₙ-Cₘ relate to the number of carbon atoms possible in the context of the invention for a respective class of compounds. Alkyl groups may be linear or branched. Cₙ-Cₘ-Alkylaryl represents aryl groups which carry a Cₙ-Cₘ-alkyl radical.

Examples of vinylaromatic compounds are styrene, α-methylstyrene or vinyltoluenes, such as o-vinyltoluene.

The esters of α,β-monoethylenically unsaturated carboxylic acids are in particular esters of acrylic acid, methacrylic acid, maleic acid, fumaric acid or itaconic acid. Examples of such esters are methyl (meth)acrylate, ethyl (meth)acrylate, n-butyl (meth)acrylate, isobutyl (meth)acrylate, tert-butyl (meth)acrylate, ethylhexyl (meth)acrylate, decyl (meth)acrylate or dodecyl (meth)acrylate, dimethyl maleate, di-n-butyl maleate or di-n-butyl fumarate.

Suitable vinyl and alkyl esters are vinyl acetate, vinyl propionate, vinyl n-butyrate, vinyl laurate and vinyl stearate and the corresponding allyl esters.

Particularly preferred monomers (a) are n-butyl acrylate, tert-butyl acrylate, 2-ethylhexyl acrylate, methyl methacrylate, tert-butyl methacrylate, vinyl acetate, vinyl propionate, butadiene and styrene.

The monomers (b) are preferably monomers (b′) which have high water solubility. These include the abovementioned α,β-monoethylenically unsaturated C₃-C₆-carboxylic acids, their amides, mono- or dialkylamides, N-alkylolamides and hydroxyalkyl esters and the nitriles of α,β-ethylenically unsaturated carboxylic acids. The N-vinyl derivatives of cyclic lactams and the mono- and dialkylaminoalkylamides of the C₃-C₆-carboxylic acids mentioned and the quaternization products thereof may also be used.

Particularly preferred monomers (b′) are acrylamide, methacrylamide, acrylic acid, methacrylic acid, acrylonitrile, methacrylonitrile, 2-acrylamido-2-methylpropanesulfonic acid, vinylpyrrolidone, hydroxyethyl acrylate, hydroxyethyl methacrylate, hydroxypropyl acrylate, hydroxypropyl methacrylate, N-methylolacrylamide, N-methylol-methacrylamide, quaternized vinylimidazole, N,N-dialkylaminoalkyl (meth)acrylates, N,N-dialkylaminoalkyl (meth)acrylamides, trialkylammoniumalkyl (meth)acrylates and trialkylammoniumalkyl (meth)acrylamides.

The polymers may also contain, as monomers (b), further monomers as (b″) which impart a higher strength to the polymer films obtainable from the polymers. Such monomers (b″) comprise compounds which comprise at least two nonconjugated, ethylenic double bonds. These include the diesters of dihydroxy compounds with α,β-ethylenically unsaturated dicarboxylic acids, such as ethylene glycol di(meth)acrylate, propylene glycol di(meth)acrylate, 1,3-butylene- and 1,4-butlyene glycol di(meth)acrylate and 2,2-dimethylpropylene glycol di(meth)acrylate, the vinyl and allyl esters of dicarboxylic acids, such as divinyl and diallyl maleate, divinyl and diallyl fumarate, divinyl and diallyl phthalate, and furthermore divinylbenzene, cyclopentadienyl acrylate and methacrylate, cyclohexenyl acrylate and methacrylate, tricyclodecenyl acrylate and methacrylate, N,N′-divinylimidazolin-2-one and triallyl cyanurate.

Such compounds are used as a rule in amounts of up to 5% by weight, based on the total amount of monomers.

Further examples of monomers (b″) are monomers having siloxane groups, such as vinyltrialkoxysilanes, e.g. vinyltrimethoxysilane, alkylvinyldialkoxysilanes, e.g. methylvinyldialkoxysilane, or (meth)acryloxyalkyltrialkoxysilanes, e.g. (meth)acryloxypropyltrimethoxysilane and (meth)acryloxypropyltriethoxysilane. These siloxane monomers can be used in amounts of up 2% by weight, preferably from 0.05 to 1% by weight, based on the total weight of the monomers.

Further examples of monomers (b″) are crosslinking monomers, such as, for example, glycidyl methacrylate or acetoacetoxy methacrylate.

Preferred polymer dispersions are furthermore those in which the weight average diameter d_{w} of the dispersed polymer particles is ≧100 nm and particularly preferably ≧300 nm. Usually d_{w} is <2000 nm. It is furthermore advantageous if the diameters of the dispersed polymer particles are distributed over a broad diameter range.

The d_{w} value of the particle size is defined as usual as the weight average of the particle size as determined by means of an analytical ultracentrifuge, according to the method of W. Scholtan and H. Lange, Kolloid-Z. and Z.-Polymere 250 (1972) pages 782 to 796. The ultracentrifuged measurement gives the integral mass distribution of the particle diameter of a sample. The percentage by weight of the particles which have a diameter equal to or less than a certain size can be determined therefrom.

A suitable measure for characterizing the width of the diameter distribution is the quotient Q=(d₉₀-d₁₀)/d₅₀, where dₘ is the diameter which is not exceeded by m % by weight of the dispersed polymer particles. Preferably, Q is from 0.5 to 1.5. The preparation of polymer dispersions having such a particle distribution width is known to the person skilled in the art, for example from DE-A-43 07 683.

The ratio of weight average molecular weight M_{w} to number average molecular weight Mₙ of the polymers may be from 1 to 30 or from 1 to 20 or from 1 to 8. The molecular weight can thus be distributed substantially uniformly or over a certain width.

The preparation of the polymer dispersions to be dried is known. In general, it is effected by free radical polymerization, which is preferably carried out in polar solvents, in particular in water. For establishing the desired molecular weight, chain-transfer agents can be concomitantly used. Suitable chain-transfer agents are, for example, compounds which have a thiol group and/or a silane group (e.g. tert-dodecyl mercaptan, n-dodecyl mercaptan or mercaptopropyltrimethoxysilane), allyl alcohols or aldehydes, such as formaldehyde, acetaldehyde, etc.

Suitable initiators are, for example, inorganic peroxides, such as sodium peroxodisulfate, or azo compounds. The polymerization can be effected as a solution or emulsion polymerization, depending on monomer composition.

If the polymer dispersion is prepared by emulsion polymerization, this is effected in the usual manner. In general, a protective colloid, such as polyvinyl alcohol, polyvinylpyrrolidone or cellulose derivatives, or anionic and/or nonionic emulsifiers, such as ethoxylated mono-, di- or trialkylphenols, ethoxylated fatty alcohols and alkali metal or ammonium salts of C₈-C₁₂-alkylsulfates, sulfuric acid monoesters of ethoxylated C₁₂-C₁₈-alkanols, C₁₂-C₁₈-alkylsulfonic acids, C₉-C₁₈-alkylarylsulfonic acids and sulfonated alkyldiphenyl ethers, are used. The polymerization temperature is in general in the range from 50 to 120° C., in particular from 70 to 100° C.

For adjusting the polymer particle size and its distribution, the emulsion polymerization can be carried out in the presence of a seed latex. The seed latex can be prepared separately or in situ. Processes for this purpose are disclosed in the prior art (cf. EP-A 567 811, EPA 567 812, EP-A 567 819, EP-B 40 419, EP-A 129 699, DE-A 31 47 008, DE-A 42 13 967 and DE-A 42 13 968, the content of which is hereby incorporated in its entirety by reference). In another embodiment of the present invention, the polymer dispersions are prepared in the absence of a seed latex. In this case, the particle size can be adjusted by surface-active compounds, such as protective colloids or emulsifiers.

The dispersion may be a primary dispersion, i.e. a polymer dispersion which was obtained directly by the free radical, aqueous emulsion polymerization method. It may also be a secondary dispersion, i.e. a polymer obtained by solution polymerization is subsequently converted into an aqueous polymer dispersion.

The drying of the polymer dispersion can be effected in a customary manner, for example by freeze drying or preferably by spray drying. In the case of spray drying, a procedure is adopted in which the entrance temperature of the warm air stream is in the range from 100 to 200° C., preferably from 120 to 160° C., and the exit temperature of the warm air stream is in the range from 30 to 95° C., preferably from 60 to 80° C. The spray of the aqueous polymer dispersion in the warm air stream can be effected, for example, by means of one-fluid nozzles or multi-fluid nozzles or via a rotating disk. The polymer powders are usually separated off with the use of cyclones or filter separators. The sprayed aqueous polymer dispersion and the warm air stream are preferably fed in parallel.

The phenolsulfonic acid-aldehyde condensates used according to the invention can be added as an aqueous solution or as a solid before drying to the dispersion to be dried. If it is a primary dispersion, the drying agent can be added before, during and/or after the emulsion polymerization.

In addition to the drying agents according to the invention, known drying agents, such as polyvinyl alcohol, polyvinylpyrrolidone, naphthalenesulfonic acid-aldehyde condensates, homopolymers of 2-acrylamido-2-methylpropanesulfonic acid, etc., can also be concomitantly used. Anticaking agents, such as finely divided silica, which are usually used for the drying of aqueous polymer dispersions, can also be employed in order to prevent caking of polymer powder during storage. During spray drying, the anticaking agents are as a rule sprayed in separately.

The present invention also relates to the polymer powders obtainable according to the invention. They are suitable as binders in hydraulically setting materials, paints, varnishes, adhesives, coating materials (in particular for paper) and synthetic resin renders, as described in EP-A-629 650.

The polymer powders obtainable according to the invention are particularly suitable for modifying mineral binding construction materials (mortar-like preparations) which comprise a mineral binder which consists of from 70 to 100% by weight of cement and from 0 to 30% by weight of gypsum. This is true in particular when cement is the sole mineral binder. The effect according to the invention is substantially independent of the type of cement. Depending on the project, it is therefore possible to use blast-furnace cement, oil shale cement, Portland cement, hydrophobized Portland cement, fast-setting cement, expanding cement or high-alumina cement, the use of Portland cement proving to be particularly advantageous. Regarding further details, reference may be made to DE-A 19623413.3.

Typically, the ratio of mineral binder to polymer powder is from 1:0.001 to 1:3.

Cellulose derivatives and microsilica are often added to the mineral binding construction materials for improving their processing properties. The former usually have a thickening effect and the latter usually form thixotropic agents which additionally reduce the flowability of the aqueous mortar before its solidification in the applied rest state. Calcium carbonate and quartz sand form as a rule the other aggregates. By adding antifoams (with regard to “dry mortar”, preferably in powder form), an air void content (from 5 to 20% by volume) of the solidified cementitious mortar which is suitable in practice can be achieved in the solidified state. The polymer powders obtainable according to the invention are suitable, for example, for modifying cementitious repair or reinforcement mortars. Here, customary reinforcement mortars also have natural or synthetic fibers comprising materials such as, for example, Dralon (length, for example, from 1 to 10 mm, length-related mass, for example, from 3 to 10 dtex) for increasing their ability to bridge cracks.

From 9 to 20% by weight, based on cement present, of modified polymer powder are added to the cementitious reinforcement mortar in the case of the highest crack bridging requirements, and from 4 to 9% by weight in the case of lower crack bridging requirements. Only in the case of particularly low crack bridging requirements is the added amount of modifying polymer powder, on a corresponding basis, limited to 0.1 to 4% by weight.

Typical reinforcement mortars as dry mineral binding construction material preparations consist of

from 20 to 60, preferably from 20 to 50, % by weight of mineral binder (preferably exclusively cement),
from 0.1 to 20, frequently from 0.1 to 10, % by weight of modifying polymer powder obtainable according to the invention,
up to 25% by weight of customary assistants (e.g. antifoam or thickener) and, as the remaining amount, aggregates such as, for example, sand, fillers (e.g. CaCO₃), pigments (e.g. TiO₂), natural and/or synthetic fibers.

The following examples explain the invention without limiting it.

### EXAMPLES

### 1. Preparation of the Dispersion

### 1.1 Dispersion D1

A mixture of

150 g of water,
5.6 g of a 20% strength by weight aqueous solution of an ethoxylated p-isooctylphenol (degree of ethoxylation 25),
0.48 g of a 35% strength by weight aqueous solution of a sodium salt of a sulfated and ethoxylated p-isooctylphenol (degree of ethoxylation 25), 3.9 g of a 10% strength by weight aqueous formic acid solution,
1.7 g of sodium bicarbonate and
3.4 g of a 20% strength by weight aqueous polyacrylamide solution
was heated to 90° C. Thereafter, beginning at the same time and while maintaining the internal temperature of 90° C., 742.8 g of an aqueous monomer emulsion consisting of 403.2 g of n-butyl acrylate,
140.0 g of styrene,
11.2 g of acrylamide,
5.6 g of methacrylamide, 8.4 g of a 20% strength by weight aqueous solution of an ethoxylated p-isooctylphenol (degree of ethoxylation 25),
11.5 g of a 35% strength by weight aqueous solution of a sodium salt of a sulfated and ethoxylated p-isooctylphenol (degree of ethoxylation 25) and 162.9 g of water were added to this mixture in 2 h and a solution of 3.3 g of sodium peroxodisulfate in 90 g of water was continuously added dropwise in 2.5 h. Thereafter, the reaction mixture was stirred for a further 120 min at 90° C. and cooled to 60° C. After addition of a solution of 1.1 g of tert-butyl hydroperoxide in 5.5 g of water, a solution of 0.6 g of sodium hydroxymethanesulfinate in 15 g of water was added at this temperature within 1 h and stirred for a further 0.5 h. After 15 min, cooling to room temperature and neutralization with 4 ml of a 20% by weight aqueous calcium hydroxide suspension were effected. After filtration, a dispersion having a solids content of 55.3%, a light transmittance of 0.01% strength by weight dispersion at 20° C. and a layer thickness of 2.5 cm, “LT value”) of 8% and a pH of 8.7 was obtained. The glass transition temperature (DSC midpoint, see above) of the polymer was −15° C.

### 1.2 Dispersion D2

The procedure was as in the case of dispersion D1, but the monomer emulsion feed consisted of

291.2 g of n-butyl acrylate, 252.0 g of styrene, 11.2 g of acrylamide, 5.6 g of methacrylamide, 8.4 g of a 20% strength by weight aqueous solution of an ethoxylated p-isooctylphenol (degree of ethoxylation 25),
11.5 g of a 35% strength by weight aqueous solution of a sodium salt of a sulfated and ethoxylated p-isooctylphenol (degree of ethoxylation 25) and 162.9 g of water,
and neutralization was effected with 3.5 g of a 10% strength by weight aqueous ammonia solution instead of 4 ml of a 20% strength by weight aqueous calcium hydroxide suspension. After filtration, a dispersion having a solids content of 55.4%, a light transmittance of 0.01% strength by weight dispersion at 20° C. and a layer thickness of 2.5 cm (“LT value”) of 9% and a pH of 7.3 was obtained. The glass transition temperature (DSC midpoint, see above) of the polymer was +15° C.

### 2. Preparation of the Spraying Assistant

### 2.1 Spraying Assistant S1

1.147 kg of phenol were initially taken at 60° C. and 1.38 kg of concentrated sulfuric acid were added with stirring so that the internal temperature was always below 110° C. After the end of the addition, the reaction was allowed to continue for 3 h at an internal temperature of 105 to 110° C. The reaction mixture was cooled to 50° C. and 0.84 kg of a 30% strength by weight aqueous formaldehyde solution was added continuously in 4 h, it being ensured that the internal temperature did not increase above 70° C. Thereafter, 0.75 kg of demineralized water was added, heating to 95° C. to 100° C. was effected and the reaction was allowed to continue for 4 h at this temperature. Cooling to 60° C. was effected and a further 0.83 kg of demineralized water was added. At a precipitation temperature of 65° C., 2.0 kg of a 35% strength by weight calcium hydroxide suspension in demineralized water was added until the pH of 7.2 was reached, cooling to room temperature was effected and a filtration over a 200 μm sieve was carried out.

### 2.2 Spraying Assistant SV1

1.147 kg of phenol were initially taken at 60° C. and 1.38 kg of concentrated sulfuric acid were added with stirring so that the internal temperature was always below 110° C. After the end of the addition, the reaction was allowed to continue for 3 h at an internal temperature of 105 to 110° C. The reaction mixture was cooled to 50° C. and 0.84 kg of a 30% strength by weight aqueous formaldehyde solution was added in portions within 8 h while maintaining the internal temperature of 50 to 55° C. After the end of the addition, 0.75 kg of demineralized water was immediately added, heating to 95° C. to 100° C. was effected and the reaction was allowed to continue for 4 h at this temperature. Cooling to 60° C. was effected and a further 0.83 kg of demineralized water was added. At a precipitation temperature of 65° C., 2.25 kg of a 35% strength by weight calcium hydroxide suspension in demineralized water was added, a final pH of 8.5 was thus reached and cooling to room temperature was effected.

### 2.3 Color Number of the Spraying Assistant

### Method of Determination DIN EN ISO 4630-1

The color of sample S1 and of comparative sample SV1 were determined according to DIN EN ISO 4630-1 by comparison with colors of a numbered colored scale. The standard which is closest to the sample was determined and the result stated as the Gardner color number. The degree of transmission of a 1% solution of the samples to be investigated, introduced into an 11 mm cell, was used for this purpose.

### 2.4 Molecular Weight of the Spraying Assistants

The spraying assistants were characterized with regard to their molecular weights by means of gel permeation chromatography. The discrimination was effected on 3 columns connected in series (I=300 mm, d=8 mm), which were equipped with 10 μm filters and which were loaded with polymers of defined porosity (HEMA BIO from Polymer Standard Service GmbH, Mainz, with 40, 100 and 1000 Å). The mobile phase used was a mixture of 60% by weight of a 0.1 M solution of sodium nitrate, 30% by weight of tetrahydrofuran (p.a.) and 10% by weight of acetonitrile (p.a.). 1% of acetone was added as an internal standard for the flow correction. The samples were diluted with deionized water to a solids content of 0.5% by weight and chromatographed at a flow rate of 1.50 ml/min and a temperature of 60° C. The detection was effected by UV spectrometry at a wavelength of 254 nm. Polystrenesulfonates (sodium salts M=1370-1010000 Dalton) and naphthalenemono-, napthalenedi- and napthalenetrisulfonic acid sodium salts were used for the calibration. The results are summarized in table 2.

TABLE 1
Characterization of the spraying assistants

| Spraying | Gardner | Mₙ | M_{w} | |
|---|---|---|---|---|
| assistant | color number | [g/mol] | [g/mol] | M_{w}/Mₙ |
| S1 | 11.2 | 720 | 7.800 | 10.8 |
| SV1 | 16.2 | 620 | 5.500 | 8.9 |

### 3. Spray Drying

### 3.1 Antiblocking Agent

Siperant® D17 from Degussa was used as a hydrophobic antiblocking agent. This is a precipitated silica having a specific surface area (based on ISO 5794-1, annex D) of 100 m²/g, a mean particle size (based on ASTM C690-1992) of 7 μm and a tamped density (based on ISO 787-11) of 150 g/l, the surface of which was hydrophobized by a treatment with a special chlorosilane.

### 3.2 Preparation of the Spray-Dried Polymer Powders

The spray drying was effected in a Minor laboratory dryer from GEA Wiegand GmbH (Niro business division) with atomization by a two-fluid nozzle and powder separation in a fabric filter. The tower entrance temperature of the nitrogen was 135° C. and the exit temperature 70° C. 2 kg of a spray feed per hour were metered in.

The spray feed was prepared in such a way that one part by weight of the aqueous spray assistant solutions S1 and SV1 at room temperature, diluted to 20%, were added per 5 parts by weight of the aqueous polymer dispersions D1 and D2 diluted to 40%, and mixed homogeneously with stirring.

Simultaneously with the spray feed, 2% by weight of the hydrophobic antiblocking agent Sipernat® D17, based on a solids content of the spray feed, were metered continuously into the top of the spray tower via a weight-controlled double screw. Polymer powders P1 and P2 according to the invention were obtained from the aqueous polymer dispersions D1 and D2 with the use of spraying assistant S1. Polymer powders of comparative examples PV1 and PV2 were obtained from the aqueous polymer dispersions D1 and D2 with the use of spraying assistant SV1. The powder yields obtained in the spray drying are stated in table 2.

### 3. Assessment of the Spray-Dried Polymer Powders

### 3.1 Redispersion Behavior

In each case 30 g of the polymer powders obtained were homogenously mixed at room temperature in a cylinder with 70 ml of deionized water by means of an Ultraturrax apparatus at 9500 revolutions per minute. Thereafter, the aqueous polymer dispersions obtained were allowed to stand for 4 hours at room temperature and then assessed visually with regard to the extent to which the polymer phases had separated in the aqueous phases. If no phase separation at all was observable, the redispersion properties were rated as “good”. In the case of a phase separation, the redispersion properties were rated as “poor”. The results are summarized in table 2.

### 3.2 Visual Assessment of the Polymer Powders Obtained

The color of the polymer powders obtained was assessed visually. The results obtained are shown in table 2.

TABLE 2
Assessment of the spray-dried polymer powders

| | | Spraying | Yield | | |
|---|---|---|---|---|---|
| Powder | Dispersion | assistant | [% by wt.] | Color | Redispersibility |
| P1 | D1 | S1 | 80 | colorless | good |
| P2 | D2 | S1 | 85 | colorless | good |
| PV1 | D1 | SV1 | 81 | brown-red | good |
| PV2 | D2 | SV1 | 84 | brown-red | good |

We claim:

1. A process for the preparation of a phenolsulfonic acid-aldehyde condensate, wherein the rate of addition is chosen so that the reaction temperature does not exceed 80° C. and the neutralization of the resulting phenolsulfonic acid condensate does not take place beyond a pH of 8.

2. The process according to claim 1, wherein the phenolsulfonic acid-aldehyde condensates are used in the form of their alkali metal or alkaline earth metal salts or of the ammonium salts.

3. The process according to either of claims 1 and 2, wherein the aldehydes are selected from the group consisting of formaldehyde, acetaldehyde, glyoxal, glutaraldehyde or mixtures thereof.

4. The process according to any of claims 1 to 3, wherein the aldehyde used is formaldehyde.

5. The use of the phenolsulfonic acid-aldehyde condensate prepared by the process according to any of claims 1 to 4 as a spraying assistant for drying aqueous polymer dispersions.

6. The use according to claim 5, wherein the polymer of the dispersion has a glass transition temperature below 65° C.

7. The use according to either of claims 5 and 6, wherein the polymer is composed of a) from 80 to 100% by weight of at least one monomer which is selected from vinylaromatic compounds, esters of α,β-unsaturated C₃-C₆-carboxylic acids or C₄-C₈-dicarboxylic acids with C₁-C₁₂-alkanols, vinyl or allyl esters of C₁-C₁₂-carboxylic acids, vinyl chloride, vinylidene chloride and butadiene and b) from 0 to 20% by weight of at least one further monomer which has at least one ethylenically unsaturated bond.

8. The use according to claim 7, the monomer a) being selected from n-butyl acrylate, tert-butyl acrylate, 2-ethylhexyl acrylate, methyl methacrylate, tert-butyl methacrylate, vinyl acetate, vinyl propionate, butadiene and styrene.

9. The use according to claim 7, the monomer b) being selected from (meth)acrylic acid, (meth)acrylamide, (meth)acrylonitrile, acrylamido-2-methylpropanesulfonic acid, vinylpyrrolidone, hydroxyethyl (meth)acrylate and/or hydroxypropyl (meth)acrylate.

10. A process for drying polymer dispersions, wherein at least one of the phenolsulfonic acid-aldehyde condensates defined in claims 1 to 4 is used as a drying agent.

11. The process according to claim 10, wherein from 1 to 30% by weight, in particular from 3 to 15% by weight, of drying agent, based on the polymer, are used.

12. The process according to claim 10 or 11, wherein the drying of the polymer is effected by spray drying.

13. The process according to claim 12, wherein the entrance temperature of the warm air stream is from 100 to 200° C. and the exit temperature is from 60 to 95° C.

14. A polymer powder obtainable by a process according to any of claims 10 to 13.

15. The polymer powder according to claim 14, comprising a drying agent as defined by claims 1 to 4.

16. The use of the polymer powder according to claim 14 or 15 as a binder in hydraulically setting and hardening materials, paints, varnishes, adhesives, coating materials and synthetic resin renders and for modifying mineral construction materials.

17. A mineral binding construction material comprising a polymer powder according to either of claims 14 and 15.

18. The mineral binding construction material according to claim 17 in the form of a dry mortar preparation, consisting of
from 10 to 60% by weight of mineral binder,
from 0.1 to 35% by weight of polymer powder according to either of claims 14 and 15, up to 25% by weight of customary assistants and, as the remaining amount, aggregates, such as sand, fillers, pigments, natural fibers and/or synthetic fibers.
